(19) United States
(12) Patent Application Publication
(10) Pub. No.: US 2007/0224867 A1
(43) Pub. Date: Sep. 27, 2007

(54) Latching dual contact socketfor testing ball grid array devices

(76) Inventors: Thomas Avery Allsup, Dallas, TX (US); Raymond Woodrow Blasingame, Richardson, TX (US)

Correspondence Address: Thomas Allsup, 15711 Mapleview Circle, Dallas, TX, 75248-4224, US

(21) Appl. No.: 10/983,935

(22) Filed: Nov. 8, 2004

(51) Int. Cl. H01R 11/01

(52) U.S. Cl. 439/266

(57) ABSTRACT

A test and burn-in socket for ball grid array type devices is disclosed. This socket is a true open top device in that there is no contact on the upper surface of the device under test. The test and burn-in socket further features dual contacts for simultaneous voltage and current measurements (Kelvin contacts). The socket additionally provides that the dual contacts serve as a latching mechanism to hold the device in place throughout the test and burn-in process.

### BACKGROUND OF THE INVENTION

1. Field of Invention

This invention relates to making interconnections between electronic components, especially microelectronic components and, more particularly, to providing techniques for making temporary connections between semiconductor packages and circuit boards for test and burn-in.

2. Description of Prior Art

When a semiconductor manufacturer develops a new electronic device, it is subjected to a series of tests prior to production release. A common way to accelerate these qualification tests is to operate the device in a high temperature chamber. This testing at high temperatures is known as burn-in. During some qualification testing, certain electronic devices exhibit a high rate of infant mortality. Infant mortality refers to the early-life failures often observed in the “bath tub” shape statistical distribution of failures versus time. Devices of this type can usually be expected to function for years if they survive the initial hours of operation. When necessary, production lots can be screened for early failures by subjecting the devices to burn-in.

It is possible to solder the devices directly to a PCB and remove the devices after the burn-in but this is time-consuming, costly and potentially damaging to the device. A burn-in socket forms a temporary mechanical “nest” to hold the device and provide electrical contact during test or burn-in without damaging it.

There are many standard semiconductor package styles, each with a unique socket type and interconnection mechanism. The Ball Grid Array (BGA) device is a device made up of a substrate with solder balls on the bottom. When applied to a Printed Circuit Board (PCB) in the soldering process, the balls become liquid, wet the PCB metal pattern, and then solidify to form the electrical connection between the BGA device and the PCB. In a burn-in socket the solder balls must make intimate but temporary electrical contact between the BGA device and the PCB.

Various burn-in board sockets have been designed to accept the BGA device. Conventional BGA sockets usually come in one of three forms, spring probes, single cantilever beam, or dual split beam “tweezers”. These conventional methods each have business and technological strengths and weaknesses. However, none of these methods can be configured to provide two electrically isolated separate points of contact to each solder ball, known as a Kelvin contact, which is required for sensitive measurements prior to, during, and/or after the test or burn-in process. The latching function has the important quality that it obviates the need for a cap or other feature to press the DUT into the electrical contacts, resulting in a simpler test socket and one that is more easily operated in addition to providing better heat transfer than a clamped or clamshell circuit.

Of particular concern is the possibility that if electrical contact is on the lower part of the solder ball, during the test and burn-in the pressure between the temporary contacts and the solder ball may deform the solder ball under the elevated temperature conditions. Thus it would be possible that voids will be created that interfere with the final soldering process resulting in a defective electrical contact. Having the contact above the “equator” of the solder ball avoids this possibility.

### OBJECTS AND ADVANTAGES

It is an object of the present invention to provide a dual point contact probe for each solder ball of BGA devices.

It is also an object of the present invention to provide for each solder ball of a BGA device a dual point contact probe that grasps the device by the solder balls and holds it in position for the test and burn-in.

It is also an object of the present invention to provide for each solder ball of a BGA device a dual point contact probe that allows for simple interchange of BGA devices.

It is also an object of the present invention to provide for each solder ball of a BGA device a dual point contact probe that is configured so as to minimize damage to the solder ball during burn-in.

It is also an object of the present invention to provide for each solder ball of a BGA device a dual point contact probe that is compatible with sensitive measurements.

### BRIEF SUMMARY OF THE INVENTION

In the test socket described herein, the socket of open top construction is ready to accept a Ball Grid Array (BGA) device for testing by pressing downward on a cap. This cap completely covers the socket except for an opening in the center for inserting the device. Pressing downward retracts the dual contact leads to allow insertion of the BGA device. After insertion, releasing the cap will bring the dual contacts into contact with the solder ball such that the point of contact is on the device side, or the upper hemisphere of the spherical solder ball, rather than on the lower hemisphere. Thus, the dual contacts serve to hold or latch the device in position. Another feature of contact on the upper hemisphere of the solder ball is that if there is a deformation of the solder ball during the burn-in it will occur above the electrical contact area of the finished device. A deformation on the lower hemisphere, as might occur if contact were in the lower hemisphere, might lead to voids and imperfect solder joints at final assembly.

The dual contacts are electrically insulated from each other, so that one may be used as an electrical “force” line and the other may be used as an electrical “sense” line, an arrangement commonly referred to as a true Kelvin contact.

Upon completion of the test and burn-in the cap is depressed, retracting the dual contacts and allowing removal of the Device Under Test (DUT).

### BRIEF DESCRIPTION OF THE DRAWINGS

FIG. 1 is a cutaway perspective of one embodiment of the test socket, showing dual contacts in position for testing the BGA device.

FIG. 2 shows detail of one embodiment of the dual contact arrangement in testing position.

FIG. 3 shows the dual contact set in a retracted position and a solder ball entering or leaving the test socket.

FIG. 4 shows a sectional view of the socket with dual contacts in the testing positions.

FIG. 5 shows a single contact with a low friction coating applied to the top surface.

FIG. 6 is an optional disposable film or mask to prevent scratching of the underside of the device during removal.

FIG. 7 is a plan view sectional showing the solder ball in the ball support pocket with the contacts and the dielectric insulator between them.

FIG. 8 is a cutaway perspective view an open top socket with dual contacts of a different design.

### LIST OF ELEMENTS IN THE DRAWINGS

10. Socket Base with Integrated Ball Support Pocket
12. Contact—Left Side
14. Dielectric Insulator
16. Contact—Right Side
18. Socket Cap
20. Device Under Test (DUT)
30. Simple Base with Integrated Ball Support Pocket
32. Portion of Device Under Test (DUT)
34. Single Ball of Device Under Test (DUT)
36. Cap—Contact Activator
40. Scratch Protective Coating
50. Bottom Side Mask
60. Contact—Left Side
62. Contact—Right Side

### DETAILED DESCRIPTION OF THE INVENTION

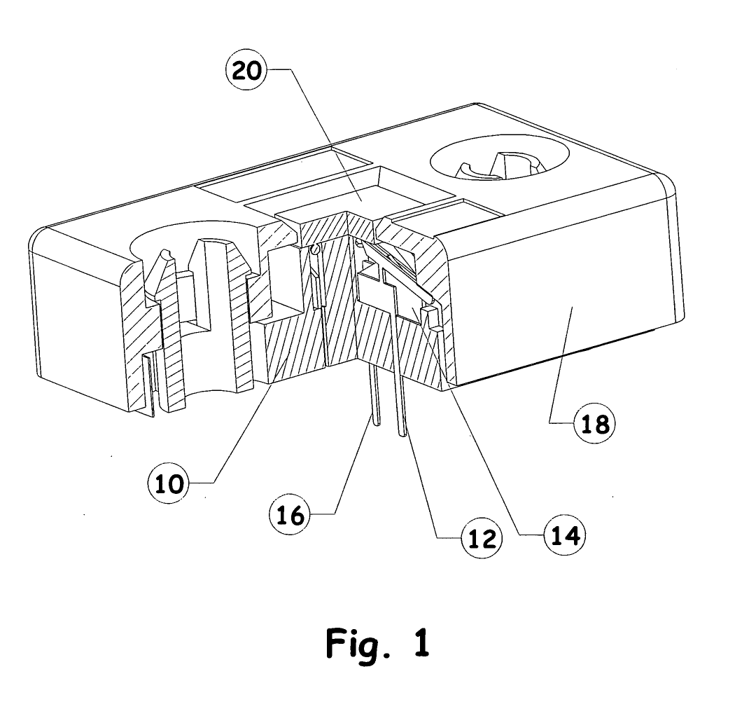

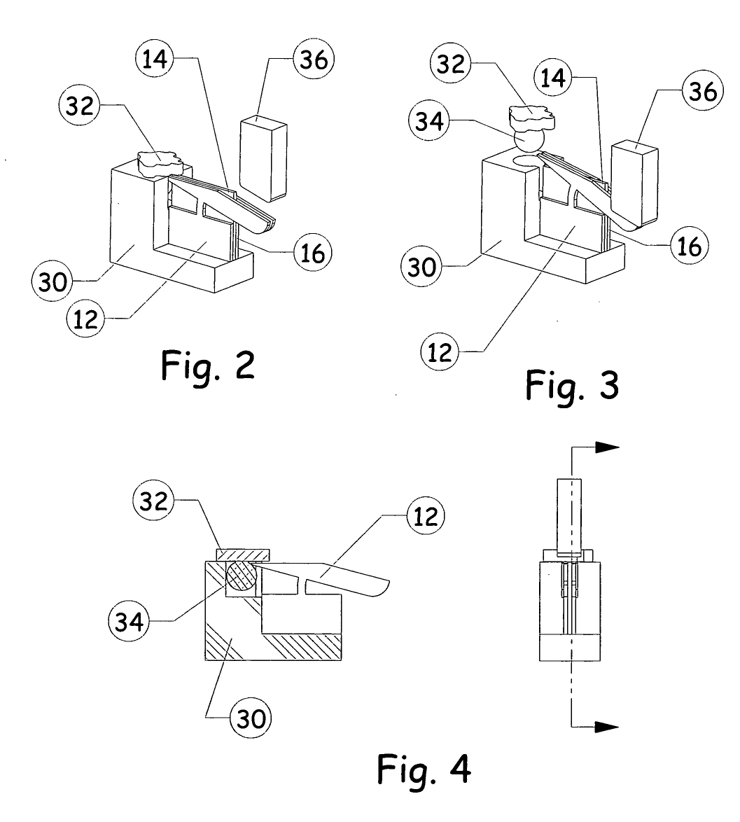

FIG. 1 shows one embodiment of the test socket, an open top type. In this arrangement a cap 18 can be moved in a vertical direction to engage and disengage the dual contacts 12 and 16 for measurement. The operation can be seen more clearly in FIGS. 2 and 3. The two contacts are moved simultaneously by the upward and downward motion of cap 18 (represented for simplicity in FIGS. 2 and 3 by block 36). Movement of the contacts occurs through a flexure of the narrowed area between the upper and lower parts of the contact. Release of cap 18 allows the contacts to come into contact with solder ball 34, as shown in FIGS. 3 and 4. The contacts are so designed that in the testing process they provide a latching action that holds the device under test securely in place by means of a downward force on the solder ball as shown in FIG. 4.

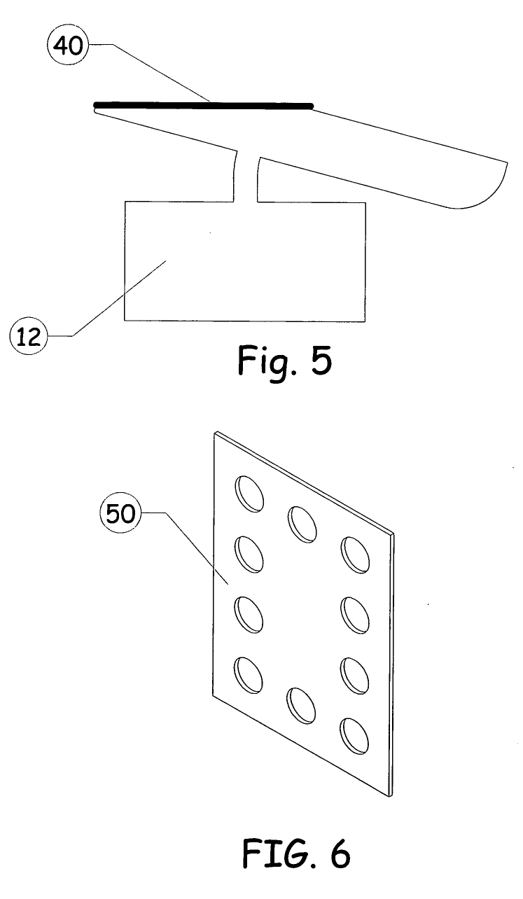

Upon completion of the test, a downward pressure on cap 18 (as represented here by block 36) lifts the contacts up and outward so the device may be removed. In this embodiment, to facilitate removal the contacts actually lift the device somewhat by contact with the under surface of the DUT 20 or 32. To prevent any possible scratching of the solder mask on the underside of the device, the contacts may be coated on the top sides with a protective material such as polytetrafluoroethylene (PTFE), shown as 40 in FIG. 5. Alternatively, a bottom side mask 50, shown in FIG. 6, containing openings to allow the solder balls to pass through may be incorporated into the socket design. This bottom side mask 50 can be captured within the socket by tabs (not shown) so as not to interfere with insertion and removal of the device. The bottom side mask can be disposable so that after a certain number of tests it will be replaced if wear becomes a problem.

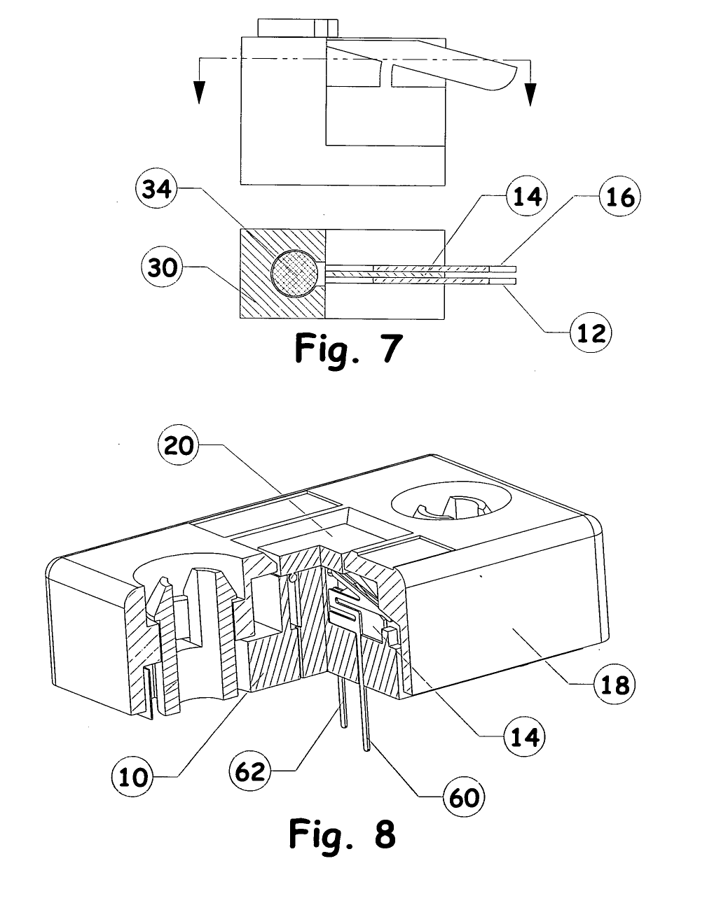

FIG. 7 is a section through a solder ball 34 showing the relationship of the two contacts 12 and 16, the insulator 14 and the solder ball 34. It will be noted that the solder ball 34 resides in a support pocket in the socket base 10 or simple base 30 of the socket, which provides support against the pressure of the contacts against it.

FIG. 8 is a cutaway perspective of a socket with a modified contact design, items 60 and 62. In this embodiment the motion of the contacts is somewhat different. When cap 18 is pressed downward, the movement of the contacts is more nearly horizontal because of the geometry of the contact. The virtually horizontal motion of the contacts 60 and 62 does not lift the DUT 20, but simply pulls the contacts away from the solder ball 34 allowing the DUT 20 to be lifted out of the socket base 10. In this embodiment there is no contact with the undersurface of the device, hence no concern about the possibility of scratching the solder mask of the DUT.

Although two designs for contacts have been disclosed, the effectiveness of the test and burn-in socket is by no means limited to the use of these two designs. Modifications of the contacts will no doubt occur to those practicing in the field, and are intended to be included herein where they provide essentially the same function.

I claim:

1. A socket for testing and burning-in ball grid array (BGA) devices, comprising:
A carrier body for supporting the device under test (DUT),
A set of dual contacts sufficient to make electrical contact with each of the solder balls at two points and provide mechanical latching by making contact in the upper hemisphere of the solder ball, and
A mechanism to extend or retract said electrical dual contacts.

2. A socket according to claim 1 wherein said socket is of the open top type.

3. A socket according to claim 1 wherein said electrical dual contacts are insulated from each other and provide for simultaneous measurement of voltage and current (Kelvin contacts).

4. A socket according to claim 1 wherein said dual contacts provide a lifting of the DUT for removal after testing.

5. A socket according to claim 1 wherein said dual contacts retract in a substantially horizontal plane without contact with the body of the device.

6. A socket according to claim 1 wherein said dual contacts are provided with a protective coating on the upper surface.

7. A socket according to claim 1 containing a disposable film between the upper surface of the contacts and the lower surface of the body of the device under test.
